(19) United States
(12) Patent Application Publication
(10) Pub. No.: US 2026/0050569 A1
(43) Pub. Date: Feb. 19, 2026

(54) SUBSET INSTRUCTION SET ARCHITECTURE

(71) Applicant: Pragmatic Semiconductor Limited, Cambridge (GB)

(72) Inventor: Emre OZER, Cambridge (GB)

(73) Assignee: Pragmatic Semiconductor Limited, Cambridge (GB)

(21) Appl. No.: 19/367,869

(22) Filed: Oct. 24, 2025

Related U.S. Application Data
(63) Continuation of application No. PCT/GB2024/051044, filed on Apr. 22, 2024.

(30) Foreign Application Priority Data
Apr. 24, 2023 (GB) 2305987.6

(51) Int. Cl. G06F 15/78; G06F 9/30

(52) U.S. Cl. CPC G06F 15/7814; G06F 9/30007

(57) ABSTRACT

A method of generating a design for a processor in accordance with a subset instruction set architecture is disclosed in which a subset of one or more instructions, from a set of instructions for an instruction set architecture is obtained. A representation of hardware for implementing each instruction of the subset is retrieved from a library that includes a representation of hardware for implementing each instruction of the set of instructions. A further representation of hardware for implementing the processor in accordance with the subset instruction set architecture is generated using the retrieved representations of hardware for implementing the instructions of the subset.

### RELATED APPLICATION(S)

This application is a Continuation of PCT Patent Application No. PCT/GB2024/051044 having International filing date of Apr. 22, 2024, which claims the benefit of priority of United Kingdom Application No. GB 2305987.6 filed on Apr. 24, 2023. The contents of the above applications are all incorporated by reference as if fully set forth herein in their entirety.

### FIELD AND BACKGROUND OF THE INVENTION

This invention relates to a method of generating a reduced or subset instruction set architecture (‘sub-ISA’) for a processor. The subset instruction set is generated from a library of instruction representations derived from an existing full instruction set architecture. The invention allows for the design and manufacture of bespoke processors for purpose or domain-specific uses, for example for low-power applications. Various such applications are discussed.

An instruction set architecture (ISA) is that part of an abstract model of a computer which defines how the central processing unit (CPU) may be controlled by software, including data handling, memory, arithmetic and logic operations. Examples of ISAs include, for example: those compatible with the Intel 8086 processor and its successors (x86 and the like); advanced reduced instruction set computer (RISC) machine ISAs; and open standard ISAs like RISC-V. RISC ISAs are characterised by fewer, simplified, instructions relative to earlier (e.g., x86) ISAs (known as complex instruction set computer (CISC) ISAs). For example, the RV32I (a variant of RISC-V) architecture has around 40 instructions whereas Intel's x86 architecture currently includes over hundreds of instructions.

A CPU is typically designed at a level of abstraction, referred to as the register-transfer level (RTL) in which the behaviour of the circuit is defined in terms of the data transfers between registers, as well as the operations performed on that data. RTL abstraction typically involves generating a description of a digital circuit (such as a microprocessor or the like) in a specialised language for describing the structure and behaviour of electronic circuits known as a hardware description language (HDL). Examples of HDL include Verilog and VHDL. Typically, design of a CPU begins with an ISA and involves construction of a suitable CPU pipeline (instructions such as fetch, decode, register read, execute, write-back etc.) to support the full ISA.

A given RTL design is, in effect, a fabrication technology independent design that can be converted to a technology specific gate-level netlist, for a particular cell library and set of design constraints associated with a corresponding technology, through a process called synthesis. This allows the same RTL design to be respectively synthesised for each of a plurality of different fabrication technology specific implementations.

Recent trends in ISA and CPU design are towards more sophistication in the ISAs and thus higher-powered CPUs, especially in the silicon chip industry. However, some software applications may not require the CPU to make use of the entire instruction set. Potentially, savings would be made in manufacturing complexity, silicon area and power consumption by designing CPUs which run only the required subset of the full ISA, i.e. a ‘sub-ISA’.

However, it is very difficult to modify the HDL description of a CPU which has been designed to support the full ISA to work with only a subset of instructions. This is because CPU designers generally follow textbook principles to design CPUs which are compliant with the full ISA. For example, an instruction decoder is designed to decode all the instructions in the ISA; an arithmetic logic unit (ALU) is designed to execute all arithmetic and logical instructions in the ISA; a generic load/store unit is designed to support all variant load and store instructions in the ISA, and so on. Such decoder, ALU and load/store units are therefore essentially hard-coded in the HDL description of a particular CPU.

Attempts have been made to derive a sub-ISA CPU from an RTL abstraction of an already designed CPU supporting the full ISA using formal methods (N. Bleier, J. Sartori and R. Kumar, “Property-driven Automatic Generation of Reduced-ISA Hardware,” 2021 58th ACM/IEEE Design Automation Conference, 2021, pp. 349-354). This uses a framework for automatically generating reduced-ISA hardware in which, for a given arbitrary RTL or gate-level netlist, property checking is used to identify gates that are not required if only a reduced ISA needs to be supported, and automatically eliminating these unnecessary gates to generate a new design. This approach effectively adopts a conventional method of starting with an existing CPU supporting the full ISA, and then subtracting instructions and their associated gates. However, this method is quite cumbersome and has not resulted in significant reduction in the silicon area or footprint of the resultant CPU. The main reason for this is that there is not much opportunity to remove gates from a design which supports the full ISA. For example, removing instructions from the ISA does not usually have significant impact on reducing the size of an ALU.

There is therefore a need for an alternative approach to the design and manufacture of sub-ISA processors.

### SUMMARY OF THE INVENTION

In a first aspect the invention provides a method of generating a design for a processor in accordance with a subset instruction set architecture, the method comprising: obtaining a subset of one or more instructions from a set of instructions for an instruction set architecture; retrieving, from a library, a respective representation of hardware for implementing each instruction of the subset, wherein the library includes a respective representation of hardware for implementing each instruction of the set of instructions; and generating, using the retrieved respective representation of hardware for implementing each instruction of the subset, a further representation of hardware for implementing the processor in accordance with the subset instruction set architecture.

The further representation of hardware for implementing the processor may be a fabrication technology independent representation. The further representation of hardware for implementing the processor may be defined at a register-transfer level (RTL). The further representation of hardware for implementing the processor may be defined in a hardware description language (HDL).

The method may further comprise generating a fabrication technology dependent representation of hardware for implementing the processor from the further representation of hardware for implementing the processor.

The further representation of hardware for implementing the processor may be a fabrication technology dependent representation.

The obtaining the subset may comprise identifying, from the set of instructions for the instruction set architecture, one or more instructions required for at least one of an application, or a domain, and including each identified instruction in the subset. The identifying the one or more instructions may comprise identifying each instruction based on a fabrication technology dependent representation of that instruction. Each fabrication technology dependent representation may be retrieved from a further library that includes a respective fabrication technology dependent representation of hardware for implementing each instruction of the set of instructions. The identifying the one or more instructions may comprise selecting an instruction for performing an operation, from a plurality of different candidate instructions for performing the operation. The selecting the instruction may comprise selecting an optimal instruction, from the plurality of different candidate instructions, based on one or more constraints. The selecting the instruction may comprise selecting the instruction, from the plurality of different candidate instructions, randomly.

The further representation of hardware for implementing the processor in accordance with the subset instruction set architecture may include a respective representation of hardware for implementing each instruction of the subset, and a representation of hardware for implementing a demultiplexer for switching between the respective representation of hardware for implementing each instruction.

The further representation of hardware for implementing the processor in accordance with the subset instruction set architecture may include a representation of hardware for implementing an instruction selector for providing an input to the demultiplexer for selecting a specific representation of hardware for implementing a specific instruction.

In a second aspect the invention provides a method of manufacturing a processor, the method comprising: generating a design for a processor in accordance with a subset instruction set architecture using a method of the first aspect; and fabricating the processor based on the further representation of hardware for implementing the processor in accordance with the subset instruction set architecture.

In a third aspect the invention provides a processor manufactured in accordance with the method of the second aspect.

In a fourth aspect the invention provides an electronic device comprising a processor according to the third aspect.

The electronic device of the fourth aspect may be a product identifier and/or location tracker.

The electronic device of the fourth aspect may be incorporated into packaging, a wound dressing and/or monitoring patch, or a wearable.

In a fifth aspect the invention provides a method of generating a library of representations of hardware for implementing a set of instructions of an instruction set architecture, the method comprising: generating a respective representation of hardware for implementing each instruction of the set of instructions; and storing each generated representation of hardware for implementing an instruction in a database.

The method may further comprise respectively verifying the functionality of each representation of hardware. Each representation of hardware for implementing an instruction may be a fabrication technology independent representation. Each representation of hardware for implementing an instruction may be defined at a register-transfer level (RTL). Each representation of hardware for implementing an instruction may be defined in a hardware description language (HDL).

Each representation of hardware for implementing an instruction may be a fabrication technology dependent representation. Each representation of hardware for implementing an instruction may be a gate-level representation.

In a sixth aspect the invention provides a computer program product comprising instructions which, when the program is executed by a computer, causes the computer to carry out the method of any preceding aspect.

### BRIEF DESCRIPTION OF THE SEVERAL VIEWS OF THE DRAWING(S)

The invention will now be described, purely by way of example, with reference to the accompanying drawings, in which:

FIG. 1 shows a methodology for the generation of a sub-ISA in overview;

FIG. 2 shows the sub-ISA generation process in more detail;

FIG. 3 shows generation of a full ISA hardware representation library;

FIG. 4 shows generation of a full ISA gate-level representation library;

FIG. 5 shows an example sub-ISA instruction selection process;

FIG. 6 shows another example sub-ISA instruction selection process;

FIG. 7 shows an example of the generation of a hardware representation for a sub-ISA processor;

FIG. 8 shows a simplified block schematic for a technology independent hardware representation for a sub-ISA processor hardware architecture;

FIG. 9 shows a typical sub-ISA processor based hardware device; and

FIG. 10 shows an example healthcare use case.

### DESCRIPTION OF SPECIFIC EMBODIMENTS OF THE INVENTION

### Overview

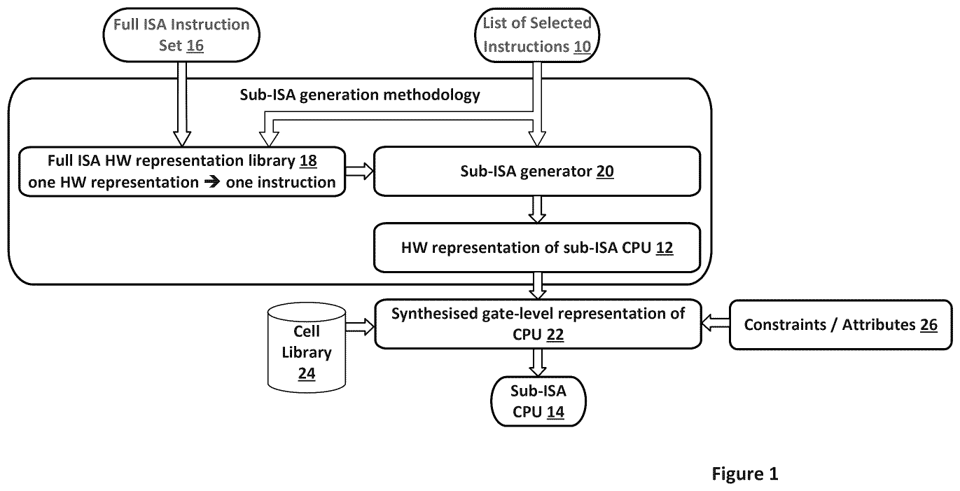

FIG. 1 shows a methodology for the generation of a sub-ISA in Overview.

As seen in FIG. 1, a list of selected instructions 10 required for a particular application is used to generate a fabrication technology independent representation 12 of the hardware (circuitry) required for a ‘sub-ISA’ processor 14 (a CPU in this example) from—a full ISA 16. The technology independent hardware representation 12 may, for example, be a register-transfer level (RTL) abstraction written in an appropriate hardware description language (HDL) such as VHDL or Verilog.

As described in more detail below, the full ISA 16 is initially used to generate a library 18 that respectively includes a separate hardware representation for each instruction of a selected set of instructions. Each hardware representation in the library may, for example, be an RTL abstraction written in an appropriate HDL. In this example the set of instructions represented in the library 18 includes all the constituent instructions of the full ISA 16. It will be appreciated, however, that the selected set of instructions may not include every instruction of the full instruction set for certain implementations/use cases.

When a new processor design is required to support a particular application, appropriate members of the full ISA 16 are selected according to the requirements of the application. The hardware representations stored in the library 18 for the resulting list of selected instructions 10 are combined in a sub-ISA generator 20, together with one or more hardware representations representing any other necessary circuit elements, to generate the hardware representation 12 for the sub-ISA processor 14.

Beneficially, in the described example, the hardware representation 12 for the sub-ISA processor 14 is a ‘pre-synthesis’ representation (e.g., defined in HDL) and is therefore fabrication technology independent. The hardware representation 12 for the sub-ISA processor 14 can thus be subject to logical synthesis, for a particular fabrication technology, to produce a synthesised fabrication technology dependent hardware representation 22 (e.g., a gate-level representation such as a gate-level netlist) from which the sub-ISA processor 14 can ultimately be produced. The logical synthesis can be based on a cell library 24 for the specific technology, and subject to any technical constraints/required attributes 26 that may be imposed for the processor being designed. Hence, the same pre-synthesis representation 12 can be used to produce different physical processor implementations based on different fabrication technologies.

It will be appreciated that while the described methodology is particularly beneficial for designing a sub-ISA CPU it can also be used, advantageously, to design a CPU supporting all instructions in the ISA. In this case the methodology can be seen to represent an alternative way to design a full-ISA CPU, in addition to a methodology for designing a sub-ISA CPU.

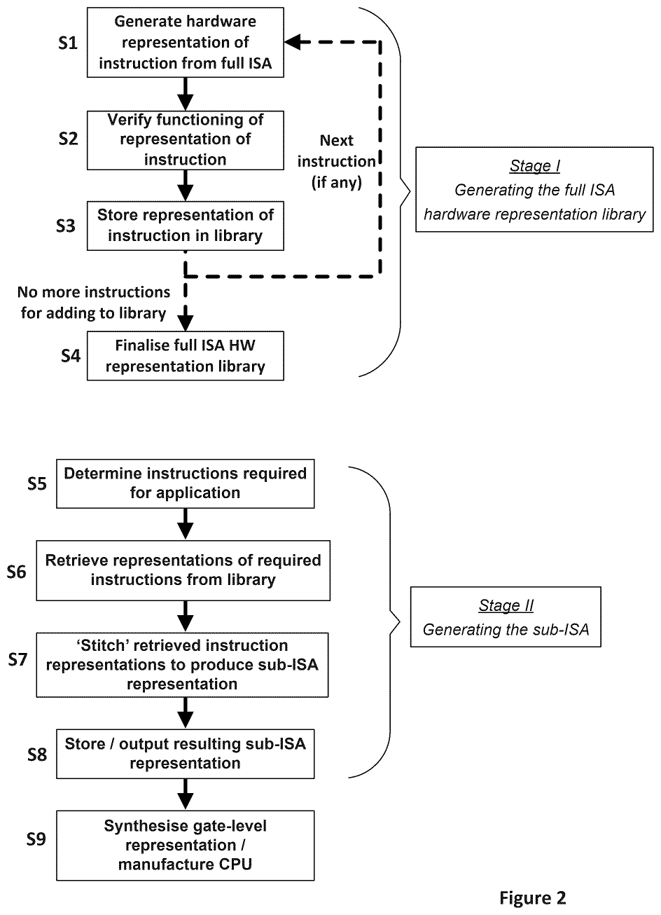

FIG. 2 shows the sub-ISA generation process in more detail, including: an initial stage I) in which the hardware representation library 18 is generated from the existing full ISA having a set of instructions clearly defined in semantics and syntax; and subsequent stage II) in which the instruction hardware representation library is (re)used to generate one or more ‘sub-ISAs’ for each application. An appropriate sub-ISA processor 14 may then be manufactured by a suitable foundry. Key steps of each of these two stages are summarised below before being described in more detail.

Stage I) generating the ISA instruction representation library:
S1) Generate a hardware representation of an instruction from the full ISA 16;
S2) Verify functioning of the generated hardware representation;
S3) Store the verified hardware representation of the instruction in the library 18; and
S4) Finalise the hardware representation library 18.

Stages S1-S3 are repeated iteratively for each instruction to be represented in the library 18 (in this example the full instruction set of that ISA). Hence, a respective hardware representation of each instruction is available in the library 18. When all the instructions requiring representation have been added to the library 18 the completed library can be finalised, as indicated at S4, for use in generating sub-ISA processors.

Stage II) generating the sub-ISA:
S5) Determine instructions required for application;
S6) Retrieve hardware representations of required instructions from library 18;
S7) ‘Stitch’ retrieved hardware representations together to produce a hardware representation 12 of the sub-ISA; and
S8) Store/output the resulting sub-ISA representation 12.
S9) Subsequently the sub-ISA representation 12 (e.g., in the form of an HDL description) is used to synthesise a technology specific representation for subsequent manufacture of a bespoke processor.

Selected steps are discussed in more detail in the following.

### Stage I) Generating the Full ISA Hardware Representation Library

### S1) Generate Representation of Instruction From Full ISA

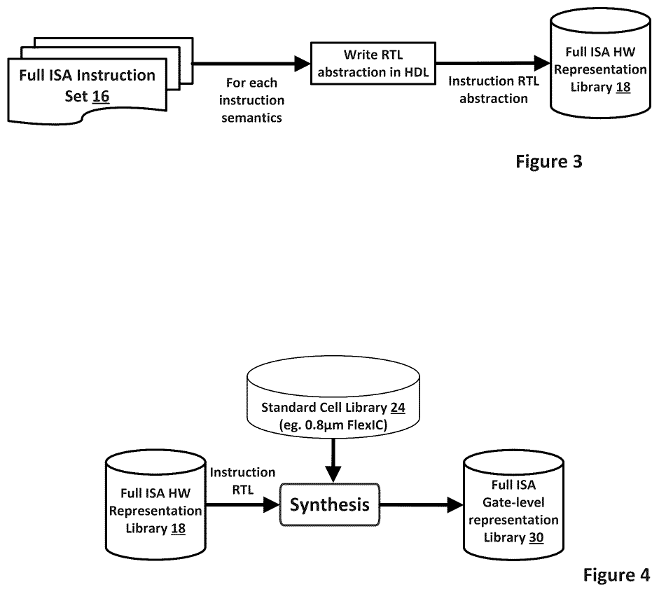

Referring to FIG. 3, which shows the generation of the full ISA technology independent hardware representation library 18 described in relation to stage I shown in FIG. 2, the respective representation of each instruction in the full ISA is typically written as an RTL abstraction in HDL. Accordingly, the semantics for each instruction are, in effect, designed in hardware as if only that instruction is to be run by the sub-ISA processor 14. This exercise is repeated, in this example, for all the instructions in the full ISA instruction set 16 and ultimately results in a library 18 that includes a respective RTL design of the semantics for each instruction in the full ISA.

Whilst the library 18 is described as having a separate hardware representation for each instruction it will be appreciated that the library 18 may also include one or more hardware representations for corresponding instruction grouping(s) (e.g., of two or more instructions that are commonly used together).

It will also be appreciated that the library generation process is generic and can be applied to any ISA (e.g., a reduced instruction set computer (RISC) ISA, a complex instruction set computer (CISC) ISA, minimal instruction set computer (MISC), etc). Moreover, while the description focuses on producing a design for a CPU by way of example, the process can be applied for producing a sub-ISA for any processor (e.g. a digital signal processor (DSP) etc.).

Moreover, whilst the generation of the library 18 may be a time-consuming process, once generated for a particular full ISA, the resulting technology independent hardware representation library 18 may be reused each time a new sub-ISA processor is required for a new use case/application.

As the library 18 is expressed at the register-transfer level, the library 18 is independent of any hardware, fabrication technology platform or process design kit (PDK) that may be used to produce a sub-ISA processor. Nevertheless, the technology independent hardware representation library 18 may be used to generate a fabrication technology specific library of hardware (‘gate-level’) representations.

For example, FIG. 4 shows generation of a full ISA gate-level representation library. As seen in FIG. 4 each hardware (RTL) representation in the library 18 may respectively be subject to synthesis 28, for a technology specific cell library/PDK 24 (e.g., Pragmatic's Helvellyn 2.1, or TSMC 14 nm), to generate a corresponding technology dependent gate-level hardware representation (e.g., in the form of a gate-level netlist). Each gate-level representation may then be stored in a full ISA gate-level representation library 30. It will be appreciated that each instruction represented as a technology dependent gate-level representation may be stored in the library 30 in association with corresponding timing, power and/or synthesis area counts. It will also be appreciated that a plurality of different gate-level representations may be generated and stored for the same instruction in the full ISA. For example, an ADD instruction could be represented at the gate level using different standard cells-one optimising one characteristic (e.g., the area) and another optimising another characteristic (e.g., timing).

The generation of the full ISA gate-level representation library 30 also represents a one-time effort, for a given fabrication technology, for the full ISA. The procedure may, nevertheless, be repeated when the corresponding technology specific cell library is modified. Specifically, when a modified cell library becomes available, the synthesis process may be re-run to generate a new gate-level representation library 30, from the original full ISA hardware (RTL) representation library 18. As the full ISA hardware (RTL) representation library 18 does not need to be regenerated this is a relatively simple and straightforward process.

The gate-level representation library 30 may, beneficially, be used in the procedure to help ensure that the resulting sub-ISA is optimised appropriately for a specific technology. The gate-level representation library 30 may, for example, be used when determining which instructions are required in the sub-ISA, as discussed in more detail later. It will be appreciated, however, that gate-level representation library 30 may not include a representation for every instruction of the full instruction set for certain implementations/use cases.

### S2) Verify Functioning of Instruction

Beneficially, the functionality of each hardware representation is verified with standard tools before it is finalised in the hardware representation (RTL) library 18. This is typically a relatively straightforward process because the semantics for each instruction are well defined in the ISA.

Hence, because the verification of each instruction is carried out when the instruction is designed as hardware, the library 18 for the full ISA may be designed and verified only once for a given ISA. The verification of each bespoke sub-ISA processor 14 therefore requires a relatively minimal effort. This simplifies the verification because each instruction RTL abstraction used to generate the design for a bespoke sub-ISA processor 14 is taken from an already verified library. Specifically, during synthesis to form the final gate-level representation, it is sufficient that the tool used for the synthesis compares the final netlist to the corresponding RTL abstraction formally (as is typically done within the synthesis tool) for functional verification.

By contrast, a conventional CPU design approach separates the CPU pipeline design from the instructions executed on the pipeline. In such conventional approaches, the CPU pipeline is designed in a generic manner and modified to support execution of the instructions in the full ISA. This complicates the process of verification because each instruction execution (or even each of many combinations of instructions in the pipeline) needs to be verified to identify ‘corner cases’, i.e. problems arising outside normal operating parameters. Consequently, in conventional CPU design approaches, the CPU verification stage can be more challenging and hence more time consuming than the CPU design stage.

### S3) Store Representation of Instruction in Library

As explained above, in this example, the hardware representations are stored as RTL abstractions, written for example in an appropriate HDL, in the hardware representation library 18.

### Stage II) Generating the Sub-ISA

### S5) Determine Instructions Required for Application

As those skilled in the art will be aware, there are a number of ways that an application (or a set of applications) and/or a specific domain (e.g., machine learning (ML), security, audio processing, or the like) for which a bespoke sub-ISA processor is to be designed may be characterised or profiled, and appropriate specific instructions for the corresponding sub-ISA identified and selected. There are, for example, many profiling tools that can characterise applications and generate an appropriate subset of instructions from a full ISA.

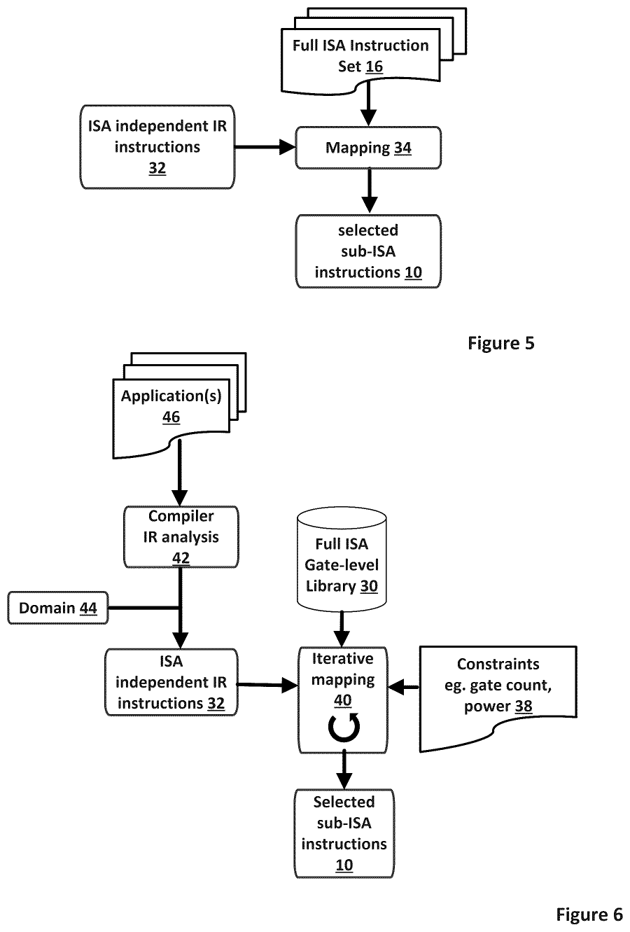

A particularly straightforward way in which instructions can be selected will now be described, by way of example only, with reference to FIG. 5, which shows an example sub-ISA instruction selection process.

As seen in FIG. 5, a list of ISA independent intermediate representation (IR) instructions 32 required for a particular domain, or for implementing a specific application (or a set of applications), may be used in the selection of instructions for a particular sub-ISA. An IR instruction is, essentially, an abstract representation of an instruction that is independent of any specific ISA instruction set and may therefore be used for selecting a corresponding instruction from any suitable full ISA. Each IR instruction in the list 32 may be subject to mapping 34 to map that IR instruction to an appropriate instruction from the full ISA 16. The instruction arising from the mapping is then selected to form part of the selected instruction subset 10 for the sub-ISA. For example, an IR instruction for an ‘ADD’ operation may be mapped to one of a plurality of different ADD instructions in the full ISA 16. Whilst the mapping 34 may be carried out manually it will be appreciated that the mapping 34 may be automated (e.g., by use of an appropriate computer implemented mapping tool such as an appropriately trained artificial intelligence (AI) or the like).

It can be seen that this example has the benefit of being relatively simple and fabrication technology independent. Nevertheless, it will be appreciated that a fabrication technology-dependent approach to instruction selection may provide other benefits, for example the ability to tailor the selection of instructions for optimisation of the resulting sub-ISA processor design to a specific technology.

A particularly beneficial technique for fabrication technology specific instruction selection will now be described, by way of example only, with reference to FIG. 6, which shows another example sub-ISA instruction selection process.

In FIG. 6, a full ISA gate-level representation library 30 for a specific technology and (optionally) a set of constraints 38 are provided as inputs to a mapping tool 40. The full ISA gate-level representation library 30 may, for example, be derived using the method described with reference to FIG. 4. The mapping tool 40 performs mapping of a list of ISA independent IR instructions 32 for a particular domain, and/or for implementing a specific application (or a set of applications), to a selected set of sub-ISA instructions in a manner analogous to the mapping 34 described with reference to FIG. 5. However, in this example, the mapping tool 40 can perform iterative mapping of each IR instruction to a plurality of different gate-level representations corresponding to candidate instructions from the full ISA (if there is more than one possible mapping). The mapping tool 40 is thus able to determine which candidate instruction is an optimal selection for the sub-ISA instruction set based on a comparison of the corresponding gate-level representations in the gate-level representation library 30 taking any associated constraints 38 (e.g., required power, performance metric, area, code size etc) into account. Accordingly, the mapping tool 40 may output the list of selected sub-ISA instructions 10.

In this example the list of ISA independent IR instructions 32 are generated based on an analysis, at the IR level, by a compiler 42. The compiler 42 analyses a domain 44, and/or an application (or a set of applications) 46 to identify appropriate IR instructions. It will be appreciated that the list of ISA independent IR instructions 32 may be generated in a similar manner.

It can be seen, therefore, that the iterative mapping tool 40 beneficially maps the IR instructions to the representations of instructions in the full ISA gate-level representation library 30 taking any associated constraints into account. In this example, the IR instruction (e.g., corresponding to the ADD operation mentioned above) can map to several variants of the corresponding (e.g., ADD) instruction from the full ISA (and/or to different gate level representations of the same ADD instruction from the full ISA). The iterative mapping tool 40 can, in effect, ‘crawl’ through the mapping space to find a near-optimal mapping. It will be appreciated that the final mapping may be determined using any appropriate optimisation methodology, for example, by-optimisation methods or evolutionary computing techniques.

Generally, where there are multiple possible matches, the best match subject to any constraints/requirements would be selected. However, where there are multiple possible mappings from which no optimal match or best-match can be determined, a mapping may be selected randomly from the multiple possible mappings.

It will be appreciated that even for a common PDK there may be a plurality of different sets of selected instructions for a reduced or sub-ISA, e.g., for different cell libraries. For example, for the same PDK one set of instructions may be selected for a standard cell library based on one transistor technology (e.g., a resistive N-type metal-oxide semiconductor (NMOS) transistor technology) and a different set of instructions may be selected for standard cell library based on a different transistor technology (e.g., pseudo-complementary metal-oxide-semiconductor (pseudo-CMOS) transistor technology).

It will be appreciated that multiple different IR instructions may be mapped directly to one or more full ISA instructions and/or corresponding gate-level representations. Moreover, the selected sub-ISA instructions may be determined separately using a different technique, rather than using one of the selection methods described above.

### S6) Retrieve Representations of Required Instructions From Library

Once the subset of instructions for the sub-ISA have been selected it is a relatively straightforward task to retrieve the corresponding hardware representations from the technology independent hardware representation library 18 for subsequent processing to generate a hardware representation for the associated bespoke sub-ISA processor.

### S7) ‘Stitch’ Retrieved Representations to Produce a Sub-ISA

After the hardware representations (i.e., RTL abstractions in this example) corresponding to the selected instructions 10 have been retrieved from the technology independent hardware representation library 18, the RTL abstractions for the selected instructions 10 are ‘stitched’ together (as in combined or integrated) to produce a hardware representation (e.g., an RTL abstraction) for the sub-ISA processor.

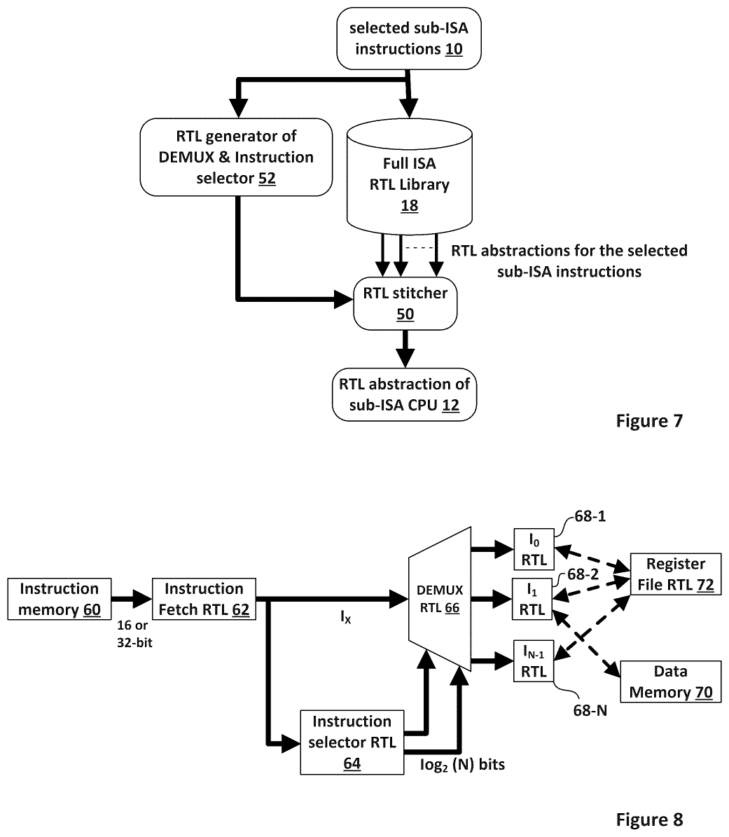

FIG. 7 shows an example of the generation of a hardware representation for a sub-ISA processor for a selected subset of instructions.

As seen in FIG. 7, the RTL abstractions corresponding to the selected subset of instructions 10 are taken from the hardware representation library 18 (the full ISA RTL library in this example). These RTL abstractions are combined by an RTL stitcher 50, together with hardware (RTL) representations for other components required, to generate the hardware (RTL) representation of the sub-ISA processor 12. In this example, hardware (RTL) representations for the other components include hardware (RTL) representations for a demultiplexer (DEMUX), and for an instruction selector which are provided by an associated RTL generator 52. It will be appreciated that this may also include hardware (RTL) representations for other components such as, for example, an instruction fetch component and/or a register file. The RTL abstraction for the demultiplexer, and the RTL abstraction for the instruction selector, can be automatically generated once the selected subset of sub-ISA instructions 10 is known.

Specifically, the RTL 50 stitcher beneficially creates the hardware representation of the sub-ISA processor automatically. As this is an abstraction from a gate-level design there is no dependence on any PDK or cell library. The processor microarchitecture generated for the selected subset of instructions 10 does not rely on any assumptions being made on how the selected subset is generated.

An exemplary sub-ISA processor architecture that can be produced using the described methodology will now be described, by way of example only, with reference to FIG. 8, which shows a simplified block schematic for a technology independent hardware (RTL) representation for a sub-ISA processor hardware architecture. Specifically, FIG. 8 illustrates a pipeline for the sub-ISA processor.

As seen in FIG. 8, every clock cycle, an instruction (i.e., the next instruction of some application code that is compiled to the selected subset of instructions 10 for the sub-ISA) is fetched from instruction memory 60 by an instruction fetch stage 62. The fetched instruction (‘Iₓ’) is sent to an instruction selector 64 and a demultiplexer (DEMUX) 66. The demultiplexer 66 is essentially a switch that can provide multiple different outputs from a single input. In the illustrated example the demultiplexer has a single input and multiple (‘N’) outputs, where ‘N’ corresponds to the number of sub-ISA instructions in the selected subset 10. The instruction selector 64 takes the instruction and generates an appropriate selection input (i.e., a log2(N) bit input) for triggering the demultiplexer 66 to switch the demultiplexer output to the instruction RTL abstraction 68-1, 68-2 . . . 68-N corresponding to the fetched instruction (‘Iₓ’). In effect, the instruction selector acts as a partial decoder in the sense that it translates the operation code (opcode) of the fetched instruction into an appropriate selection input. Nevertheless, the full decoding of the instruction will be carried out by the RTL abstraction 68-1, 68-2 . . . 68-N corresponding to the fetched instruction. Hence, every processor cycle, the demultiplexer 66 can forward the fetched instruction to the correct RTL abstraction 68-1, 68-2 . . . 68-N for that instruction, for execution. Depending on the nature of the instruction this may, for example, involve reading from or writing to a data memory 70 and/or one or more registers in a register file 72.

During subsequent synthesis to convert the technology independent representation into a technology specific gate-level representation, the synthesis tool is able to interpret the presence of the demultiplexer RTL abstraction (e.g., a switch statement with various different cases in an appropriate HDL) as an implicit indication that only a single instruction RTL abstraction will be used at any given cycle. Based on this, the synthesis tool may optimise the gate count appropriately by increasing resource sharing among the instructions of the sub-ISA.

### S8) Store/Output the Resulting Sub-ISA Representation

The resulting hardware representation of the sub-ISA processor may be provided in any suitable manner, for example as a pre-synthesis RTL abstraction (written in an appropriate HDL) and/or as a post-synthesis gate-level representation for a specific fabrication technology.

### S9) Manufacture CPU According to the Sub-ISA

The hardware representation of the sub-ISA processor can be provided to a fabrication facility for manufacturing the bespoke sub-ISA CPU implementing those instructions.

It can be seen, therefore, that the described methodology involves generating a sub-ISA from a full ISA in a bottom-up manner, i.e., synthesising a processor (CPU) designed from a subset of instructions (sub-ISA) from a given instruction set architecture (ISA). The method ultimately synthesises the processor for a given sub-ISA from each instruction in the sub-ISA. Fabrication technology independent representations of each instruction of the sub-ISA are ‘stitched’ together to provide the bespoke processor for a given program/application. The resulting processor generally benefits from having a smaller footprint than existing processors. In other words, this is an additive methodology rather than subtractive, i.e. it does not require an existing processor design from which redundant parts need to be removed. The method also does not require a prior design of execution units such as an arithmetic logic unit (ALU), load/store units associated with the instructions, etc. In particular, the method is particularly suitable for (but not restricted to) generation of microcontroller class CPUs that have shallow scalar and in-order execution pipelines.

### Example Use Cases

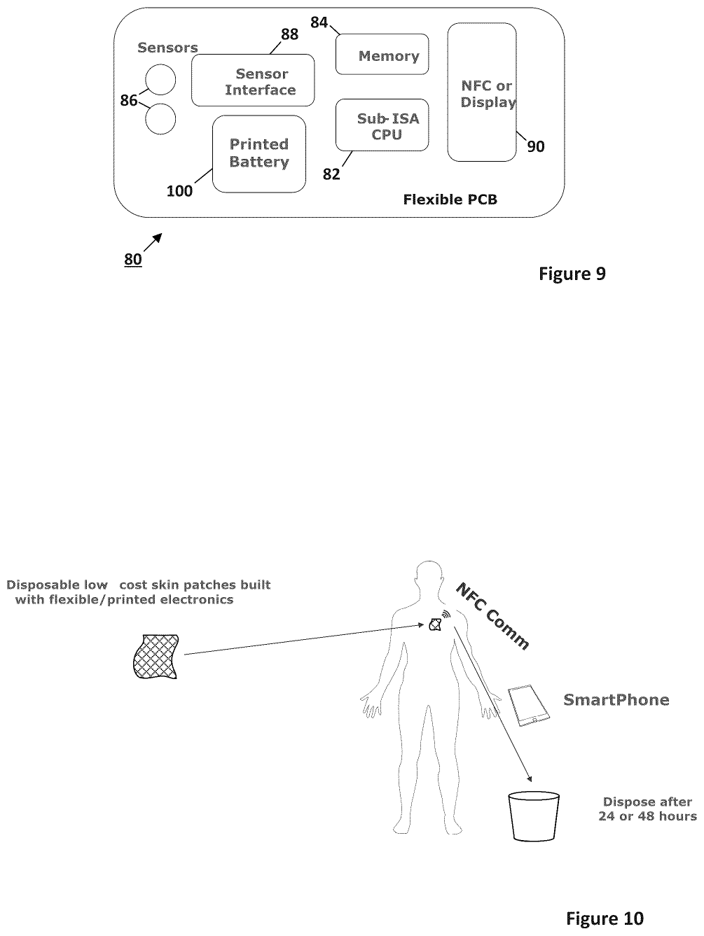

FIG. 9 shows a typical sub-ISA CPU based hardware device. In this example the hardware device comprises a flexible printed circuit board (PCB), on which is mounted a flexible sub-ISA CPU 82, an associated memory 84 and sensors 86 connected via a sensor interface 88. Data is outputted via a near-field communication, NFC, unit or display 90, and power is provided by a printed battery 100.

Evidently, the advantages of a reduced or sub-ISA processor lend themselves to many uses in which a small software program or application is required to run on a low-power CPU, for example:
Product identifiers and location trackers, e.g., using radio frequency identification (RFID), near-field communication (NFC), Bluetooth etc,
Smart packaging for Fast-Moving Consumer Goods (FMCG), e.g., monitoring of food freshness and/or calculation of expiry dates.
Mass-market healthcare applications, e.g.,
   wound dressing and monitoring, comprising a ‘smart band-aid’ with printed sensors, flexible integrated circuitry, printed battery and an OLED to display the dressing healing status
   disposable skin patches for ECG/EEG monitoring, comprising a chest-patch monitoring arrythmia conditions and alert the detected critical conditions with a sound actuator
Wearables

FIG. 10 shows an example healthcare use case, comprising a disposable, low-cost skin patch built with flexible electronics (i.e., similar to the flexible integrated circuit as shown in FIG. 9), adapted to communicate via NFC with a smartphone - and disposable after 24 or 48 hours.

The skilled person will appreciate innumerable further use cases.

It will be understood that the present invention has been described above purely by way of example, and modifications of detail can be made within the scope of the invention.

Reference numerals appearing in the claims are by way of illustration only and shall have no limiting effect on the scope of the claims.

Clause 1. A method of generating a design for a processor in accordance with a subset instruction set architecture, the method comprising: obtaining a subset of one or more instructions from a set of instructions for an instruction set architecture; retrieving, from a library, a respective representation of hardware for implementing each instruction of the subset, wherein the library includes a respective representation of hardware for implementing each instruction of the set of instructions; and generating, using the retrieved respective representation of hardware for implementing each instruction of the subset, a further representation of hardware for implementing the processor in accordance with the subset instruction set architecture.

Clause 2. A method according to clause 1, wherein the further representation of hardware for implementing the processor is a fabrication technology independent representation.

Clause 3. A method according to clause 1 or 2, wherein the further representation of hardware for implementing the processor is defined at a register-transfer level (RTL).

Clause 4. A method according to any preceding clause, wherein the further representation of hardware for implementing the processor is defined in a hardware description language (HDL).

Clause 5. A method according to any preceding clause, further comprising generating a fabrication technology dependent representation of hardware for implementing the processor from the further representation of hardware for implementing the processor.

Clause 6. A method according to clause 1, wherein the further representation of hardware for implementing the processor is a fabrication technology dependent representation.

Clause 7. A method according to any preceding clause, wherein the obtaining the subset comprises: identifying, from the set of instructions for the instruction set architecture, one or more instructions required for at least one of an application, or a domain; and including each identified instruction in the subset.

Clause 8. A method according to clause 7, wherein the identifying the one or more instructions comprises identifying each instruction based on a fabrication technology dependent representation of that instruction.

Clause 9. A method according to clause 8, wherein each fabrication technology dependent representation is retrieved, from a further library that includes a respective fabrication technology dependent representation of hardware for implementing each instruction of the set of instructions.

Clause 10. A method according to any of clauses 7 to 9, wherein the identifying the one or more instructions comprises selecting an instruction for performing an operation, from a plurality of different candidate instructions for performing the operation.

Clause 11. A method according to clause 10, wherein the selecting the instruction comprises selecting an optimal instruction, from the plurality of different candidate instructions, based on one or more constraints.

Clause 12. A method according to clause 10, wherein the selecting the instruction comprises selecting the instruction, from the plurality of different candidate instructions, randomly.

Clause 13. A method according to any preceding clause, wherein the further representation of hardware for implementing the processor in accordance with the subset instruction set architecture includes a respective representation of hardware for implementing each instruction of the subset, and a representation of hardware for implementing a demultiplexer for switching between the respective representation of hardware for implementing each instruction.

Clause 14. A method according to any preceding clause, wherein the further representation of hardware for implementing the processor in accordance with the subset instruction set architecture includes a representation of hardware for implementing an instruction selector for providing an input to the demultiplexer for selecting a specific representation of hardware for implementing a specific instruction.

Clause 15. A method of manufacturing a processor, the method comprising: generating a design for a processor in accordance with a subset instruction set architecture using a method according to any preceding clause; and fabricating the processor based on the further representation of hardware for implementing the processor in accordance with the subset instruction set architecture.

Clause 16. A processor manufactured in accordance with the method of clause 15.

Clause 17. An electronic device comprising a processor according to clause 16.

Clause 18. An electronic device according to clause 17, wherein the device is a product identifier and/or location tracker.

Clause 19. An electronic device according to clause 16 or 17, wherein the device is incorporated into packaging, a wound dressing and/or monitoring patch, or a wearable.

Clause 20. A method of generating a library of representations of hardware for implementing a set of instructions of an instruction set architecture, the method comprising: generating a respective representation of hardware for implementing each instruction of the set of instructions; and storing each generated representation of hardware for implementing an instruction in a database.

Clause 21. A method according to clause 20, further comprising respectively verifying the functionality of each representation of hardware.

Clause 22. A method according to clause 20 or 21, wherein each representation of hardware for implementing an instruction is a fabrication technology independent representation.

Clause 23. A method according to clause 20, 21, or 22, wherein each representation of hardware for implementing an instruction is defined at a register-transfer level (RTL).

Clause 24. A method according to any of clauses 20 to 23, wherein each representation of hardware for implementing an instruction is defined in a hardware description language (HDL).

Clause 25. A method according to clause 20 or 21, wherein each representation of hardware for implementing an instruction is a fabrication technology dependent representation.

Clause 26. A method according to clause 20, 21 or 25, wherein each representation of hardware for implementing an instruction is a gate-level representation.

Clause 27. A computer program product comprising instructions which, when the program is executed by a computer, causes the computer to carry out the method of any of clauses 1 to 14 or 20 to 26.

What is claimed is:

1. A computer-implemented method of generating a design for a processor in accordance with a subset instruction set architecture, the method comprising a computer:
obtaining a subset of one or more instructions from a set of instructions for an instruction set architecture;
retrieving, from a library, a respective representation of hardware for implementing each instruction of the subset, wherein the library includes a respective representation of hardware for implementing each instruction of the set of instructions; and
generating, using the retrieved respective representation of hardware for implementing each instruction of the subset, a further representation of hardware for implementing the processor in accordance with the subset instruction set architecture.

2. A method according to claim 1, wherein the further representation of hardware for implementing the processor is a fabrication technology independent representation.

3. A method according to claim 1, wherein the further representation of hardware for implementing the processor is defined at a register-transfer level (RTL).

4. A method according to claim 1, wherein the further representation of hardware for implementing the processor is defined in a hardware description language (HDL).

5. A method according to claim 1, further comprising the computer generating a fabrication technology dependent representation of hardware for implementing the processor from the further representation of hardware for implementing the processor.

6. A method according to claim 1, wherein the further representation of hardware for implementing the processor is a fabrication technology dependent representation.

7. A method according to claim 1, wherein the obtaining the subset comprises: the computer identifying, from the set of instructions for the instruction set architecture, one or more instructions required for at least one of an application, or a domain; and including each identified instruction in the subset.

8. A method according to claim 7, wherein the identifying the one or more instructions comprises the computer identifying each instruction based on a fabrication technology dependent representation of that instruction.

9. A method according to claim 8, wherein each fabrication technology dependent representation is retrieved, by the computer, from a further library that includes a respective fabrication technology dependent representation of hardware for implementing each instruction of the set of instructions.

10. A method according to claim 7, wherein the identifying the one or more instructions comprises the computer selecting an instruction for performing an operation, from a plurality of different candidate instructions for performing the operation.

11. A method according to claim 10, wherein the selecting the instruction comprises the computer selecting:
an optimal instruction, from the plurality of different candidate instructions, based on one or more constraints; or
the instruction, from the plurality of different candidate instructions, randomly.

12. A method according to claim 1, wherein the further representation of hardware for implementing the processor in accordance with the subset instruction set architecture includes at least one of:
a respective representation of hardware for implementing each instruction of the subset, and a representation of hardware for implementing a demultiplexer for switching between the respective representation of hardware for implementing each instruction; or
a representation of hardware for implementing an instruction selector for providing an input to the demultiplexer for selecting a specific representation of hardware for implementing a specific instruction.

13. A computer program product stored on a non-transitory computer-readable medium and comprising instructions which, when executed by a computer, cause the computer to:
obtain a subset of one or more instructions from a set of instructions for an instruction set architecture;
retrieve, from a library, a respective representation of hardware for implementing each instruction of the subset, wherein the library includes a respective representation of hardware for implementing each instruction of the set of instructions; and
generate, using the retrieved respective representation of hardware for implementing each instruction of the subset, a further representation of hardware for implementing the processor in accordance with the subset instruction set architecture.

14. A computer program product according to claim 13, wherein the further representation of hardware for implementing the processor is a fabrication technology independent representation.

15. A computer program product according to claim 13, wherein the further representation of hardware for implementing the processor is defined at a register-transfer level (RTL).

16. A computer program product according to claim 13, comprising instructions which, when executed by the computer, cause the computer to:
generate a fabrication technology dependent representation of hardware for implementing the processor from the further representation of hardware for implementing the processor.

17. A computer program product according to claim 13, wherein the further representation of hardware for implementing the processor is a fabrication technology dependent representation.

18. A computer program product according to claim 13, wherein:
the obtaining the subset comprises identifying, from the set of instructions for the instruction set architecture, one or more instructions required for at least one of an application, or a domain; and including each identified instruction in the subset; and
the identifying the one or more instructions comprises identifying each instruction based on a fabrication technology dependent representation of that instruction.

19. A computer program product according to claim 18, wherein each fabrication technology dependent representation is retrieved, from a further library that includes a respective fabrication technology dependent representation of hardware for implementing each instruction of the set of instructions.

20. A computer configured to generate a design for a processor in accordance with a subset instruction set architecture, the computer configured to:
obtain a subset of one or more instructions from a set of instructions for an instruction set architecture;
retrieve, from a library, a respective representation of hardware for implementing each instruction of the subset, wherein the library includes a respective representation of hardware for implementing each instruction of the set of instructions; and
generate, using the retrieved respective representation of hardware for implementing each instruction of the subset, a further representation of hardware for implementing the processor in accordance with the subset instruction set architecture.
